(19) United States
(12) Patent Application Publication
(10) Pub. No.: US 2009/0278081 A1
(43) Pub. Date: Nov. 12, 2009

(54) PAD PROPERTIES USING NANOPARTICLE ADDITIVES

(75) Inventors: Hichem M'Saad, Sunnyvale, CA (US); Lakshmanan Karuppiah, San Jose, CA (US); Hung Chih Chen, Sunnyvale, CA (US); Jeonghoon Oh, San Jose, CA (US); Robert Lum, Sunnyvale, CA (US); Stan D. Tsai, Fremont, CA (US); Cassio Conceicao, Los Altos, CA (US); Ashish Bhatnagar, Fremont, CA (US); Michael Perry, Chandler, AZ (US); Kadthala Narendrnath, San Jose, CA (US); Yosi Shacham-Diamand, Ithaca, NY (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/411,261

(22) Filed: Mar. 25, 2009

Related U.S. Application Data
(60) Provisional application No. 61/040,534, filed on Mar. 28, 2008.

(51) Int. Cl. C09K 13/00

(52) U.S. Cl. 252/79.1

(57) ABSTRACT

A method for forming a polishing media and an article of manufacture is described. The article of manufacture may be formed into a polishing article. The polishing article includes a polymer base material and a plurality of nano-scale structures disposed in or on the polymer base material.

### CROSS-REFERENCE TO RELATED APPLICATIONS

This application claims benefit of U.S. Provisional Patent Application Ser. No. 61/040,534, filed Mar. 28, 2008, which is herein incorporated by reference.

### BACKGROUND OF THE INVENTION

1. Field of the Invention

Embodiments of the invention generally relate to an apparatus and method for chemical mechanical polishing of substrates or wafers, more particularly, to a polishing media and a method of manufacture of a polishing media for chemical mechanical polishing.

2. Description of the Related Art

In the fabrication of integrated circuits and other electronic devices on substrates, multiple layers of conductive, semiconductive, and dielectric materials are deposited on or removed from a feature side of a substrate. The sequential deposition and removal of these materials on the substrate may cause the feature side to become non-planar and require a planarization process, generally referred to as polishing, where previously deposited material is removed from the feature side of a substrate to form a generally even, planar or level surface. The process is useful in removing undesired surface topography and surface defects, such as rough surfaces, agglomerated materials, crystal lattice damage and scratches. The polishing process is also useful in forming features on a substrate by removing excess deposited material used to fill the features and to provide an even or level surface for subsequent deposition and processing.

One polishing process is known as Chemical Mechanical Polishing (CMP) where a substrate is placed in a substrate carrier assembly and controllably urged against a polishing media. The polishing media may be a belt-type pad, a linear web-type pad, or a circular pad, and each pad may be mounted to a moving platen assembly. The carrier assembly provides rotational movement relative to the pad and/or the moving platen assembly, and material removal is accomplished by chemical activity, mechanical abrasion, or a combination of chemical activity and mechanical abrasion between the feature side of the substrate and the polishing media.

The conventional polishing media used to polish the feature side of the substrate include polymeric materials, such as a polyurethane material that includes essentially homogeneous chemical and frictional characteristics to provide sufficient flexibility to conform to the non-planar surface topography of the substrate while enabling a sufficient material removal rate and global polishing uniformity. However, the conventional polishing media has a limited useful lifetime, based, in part, on the hardness of the polishing media. A conventional solution to increasing the useful life includes hardening of the polishing media by altering the chemical characteristics while maintaining homogeneity, but hardening of the polishing media reduces flexibility, which may decrease global polishing uniformity.

Given the balance between flexibility and hardness of the polishing media, what is needed is a method and article of manufacture that has increased local hardness and wear resistance, while maintaining global flexibility of the media at or near that of the conventional media.

### SUMMARY OF THE INVENTION

The invention generally provides a polishing media having a plurality of local hardened areas with a global flexibility or elasticity sufficient to conform to contours in the non-planar surface of a substrate.

In one embodiment, a polishing media comprises a base portion having a first chemical characteristic and first physical characteristic and a plurality of discrete particles interspersed in the base portion. Each of the plurality of discrete areas may have a second physical characteristic that is different than the first physical characteristic while the chemical characteristic of the base portion remains substantially unaltered.

In another embodiment, a polishing article comprises a polyurethane base material having a first chemical property and a first physical property and a plurality of nano-scale structures having a second physical property that is different than the first physical property, the plurality of nano-scale structures disposed in or on the base material, wherein the first chemical property of the base material is unchanged.

In another embodiment, a method for forming a polishing media for use as a polishing article comprises providing a polymer matrix having a first chemical property and a first physical property, adding a concentration of nano-scale structures having a second physical property that is different than the first physical property to the polymer matrix in a manner that substantially maintains the first chemical property of the polymer matrix, curing the polymer matrix, and skiving the cured polymer matrix into sheets or blocks.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric cross-sectional view of one embodiment of a polishing media portion.

FIGS. 2A-2D show a polishing pad at various stages of a manufacturing process according to one embodiment.

FIGS. 3A-3E show a polishing pad at various stages of a manufacturing process according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The invention generally provides a polishing media having a plurality of local hardened areas with a flexibility or elasticity sufficient to conform to contours in the non-planar surface of a substrate. The article of manufacture includes a polishing media that may be adapted to provide a polishing surface for a linear belt, a linear web, and a circular pad or disc, each of which may be used on or with a rotating or stationary platen assembly as part of a polishing system. An example of a polishing system includes a REFLEXION® polishing system available from Applied Materials, Inc. of Santa Clara, Calif. Methods for forming a polishing media are also described.

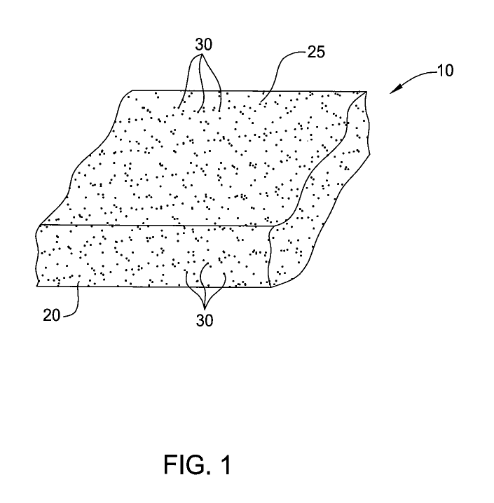

FIG. 1 is an isometric cross-sectional view of one embodiment of a polishing media portion 10 as described herein. The portion 10 is part of a larger article that may be formed to any dimension(s) and shape and may be formed as a polishing pad for use in a polishing system. The polishing media portion 10 may be formed as part of a sheet, a block, or a slice to any desired dimension and may be further formed as a linear polishing article or a circular polishing article. In the case of a linear polishing article, the media may be wound on a supply roll for use in a web-type polishing system or joined at ends to form a belt for use in a belt-type polishing system. In the case of a circular polishing article, the media may be cast, cured, cut, or trimmed into a circular shape having a diametrical dimension between about 24 inches to about 52 inches. In some applications, adhesives may be applied to a major surface of the media to provide coupling either directly or indirectly to a platen assembly.

The portion 10 includes a base material 20 having a polishing surface 25 adapted to contact a feature side of a substrate and remove material therefrom. The base material 20 includes a plurality of particles 30 that may be exposed on the polishing surface 25 and are shown interspersed in the base material 20. While not shown for clarity, the polishing surface 25 may include grooves, be embossed, and/or include pores and/or apertures that may aid in polishing, slurry transportation, among other beneficial uses. Additionally, the base material 20 may include pores and/or apertures formed therein or therethrough. The polishing surface 25 may be formed in-situ having asperities (not shown for clarity) or may be conditioned to include asperities, which may aid in polishing, slurry transportation, among other beneficial uses.

In one embodiment, the base material 20 is a polymeric material and each of the plurality of particles 30 are nano-scale materials interspersed in the base material 20. Suitable polymeric material that may be used include polyurethane, a polycarbonate, fluoropolymers, PTFE, PTFA, polyphenylene sulfide (PPS), or combinations thereof, and other polishing materials used in polishing substrate surfaces. In one embodiment, the base material 20 is a polymeric material, such as open-pored or closed-pored polyurethane material typically used in the fabrication of conventional polishing pads for service in the polishing of semiconductor wafers, and each of the plurality of particles 30 are nano-scale materials interspersed in the base material 20. A suitable base material 20 includes polymeric pad materials manufactured by Rohm and Haas, of Newark, Del., and Praxair Technology, Inc. of Danbury, Conn.

The nano-scale materials may be selected on the basis of reactivity with the chemical composition of the base material 20 wherein the chemical composition of the nano-scale materials do not significantly alter the chemical composition of the base material 20. Additionally or alternatively, a selected amount of nano-scale materials may be added to the base material at a concentration that does not significantly alter the chemical composition of the base material 20. In this manner, the physical characteristic(s) of the base material 20 is not significantly modified and allows the base material to retain desirable physical characteristics, such as flexibility.

The nano-scale materials include organic nanoparticles. In one embodiment, the nanoparticles may include molecular or elemental rings and/or nanostructures. Examples include allotropes of carbon (C), such as carbon nanotubes and other structures, molecular carbon rings having 5 bonds (pentagonal), 6 bonds (hexagonal), or more than 6 bonds. Other examples include fullerene-like supramolecules. In one application, the nano-scale materials are modified or treated with solvents, acids, amines, among other treatments. In one application, the nano-scale materials comprise a luminescent material or are coated with a luminescent material, which may provide a wear metric on the polishing surface 25. In one embodiment, at least a portion of the plurality of particles 30 disposed in or on the portion 10 comprise a fluorescent material or are coated with a fluorescent material. In one application, at least a portion of the plurality of particles 30 exposed on the polishing surface 25 are nano-materials that provide wear indications and additionally provide increased local hardness.

In one application, the nano-scale materials may be added at a concentration of about 1% to the polymer matrix before curing, and the nano-scale materials may be mechanically coupled to the polymer materials and/or polymer precursors, and combinations thereof. In another application, the nano-scale materials may be chemically bonded to the polymer material and/or polymer precursors, mechanically coupled to the polymer material and/or polymer precursors, and combinations thereof. In another embodiment, the base material 20 includes polymer-based carbon nanotube compounds having a density and concentration of carbon nanotubes that provides suitable flexibility to the base material 20. In one application, the nano-scale materials may be added to the base material 20 at a concentration of about 1% of the final product weight. In another application, the nano-scale materials may be added to the base material 20 at a concentration of about 0.5% to about 5%, such as about 0.5% to about 2% of the final product.

The nano-scale materials may include inorganic nanoparticles, such as molecular or elemental rings and/or nanostructures. In one embodiment, inorganic nanostructures may be used, such as tungsten (IV) sulfide or tungsten disulfide (WS₂), molybdenum (IV) sulfide or molybdenum disulfide (MOS₂), among other inorganic nanostructures. In one application, the nano-scale materials may be fullerene-like supramolecules of metal dichalcogenide, for example MX₂, wherein M may be molybdenum (Mo), tungsten (W), and X may be sulfur (S), selenium (Se), among other elements, compounds, combinations or derivatives thereof. The nano-scale materials may be added at a concentration of about 1% to the polymer matrix and/or polymer precursors before curing, and the nano-scale materials may be mechanically coupled to the polymer material and/or polymer precursors, chemically bonded to the polymer material and/or polymer precursors, and combinations thereof. In one application, the nano-scale materials may be added to the base material 20 at a concentration of about 1% of the final product weight. In another application, the nano-scale materials may be added to the base material 20 at a concentration of about 0.5% to about 5%, such as about 0.5% to about 2% of the final product.

In another embodiment, the nano-scale materials may comprise clay particles, wherein the clay may be a reactive clay or non-reactive clay. In another embodiment, the nano-scale materials may be a ceramic material, alumina, glass (e.g., silicon dioxide (SiO₂)), and combinations or derivatives thereof. In another embodiment, the nano-scale materials may include metal oxides, such as titanium (IV) oxide or titanium dioxide (TiO₂), zirconium (IV) oxide or zirconium dioxide (ZrO₂), combinations thereof and derivatives thereof, among other oxides.

In one embodiment, the particles 30 comprise carbon nanotubes, which may be single-walled carbon nanotubes and/or multi-walled carbon nanotubes that are uniformly yet disorderly dispersed in the base material 20. The diameter of at least a portion of the carbon nanotubes may be about 1 nanometer (nm), although a diameter greater than or less than 1 nm may be used. For example, at least a portion of the carbon nanotubes may include a diameter between about 0.8 nm to about 1.6 nm or greater. In one application, at least a portion of the carbon nanotubes comprise a length of about 1 micron (pm) to about 1000 μm. In another embodiment, at least a portion of the carbon nanotubes comprise a length of about 1 mm. In yet another embodiment, at least a portion of the carbon nanotubes comprise a length of about 100 nm to about 600 nm, although other lengths are contemplated.

In one embodiment of the portion 10, the base material 20 has a first chemical and/or physical characteristic and the plurality of particles 30 have a second chemical and/or physical characteristic that is different from the first chemical and/or physical characteristic. A physical characteristic as used herein includes properties such as hardness, specific gravity, compressibility, abrasiveness, modulus, chemical composition and/or chemical homogeneity, among other properties. In one application, each of the plurality of particles 30 that are disposed in or near the polishing surface 25 form areas of localized hardness relative to a hardness of the base material 20 and/or a hardness of the polishing surface 25 surrounding and adjacent the particles 30. A chemical characteristic as used herein includes properties such as pH, electronegativity, reactivity, among other chemical properties. In one embodiment, the chemical characteristic(s) of the plurality of particles 30 does not significantly modify the chemical characteristic(s) of the base material 20, while the physical characteristic(s) of the plurality of particles 30 alters the physical characteristic(s) of the base material 20 at an area surrounding each particle 30.

There are various types of nanoparticles that may be used. In one embodiment, the nanoparticles may comprise nanotubes. In another embodiment, the nanoparticles may comprise clay nanoparticles. In another embodiment, the nanoparticles may comprise ceramics. In another embodiment, the nanoparticles may comprise metal oxides. In another embodiment, the nanoparticles may comprise glass. Examples of carbon nanotubes include multi wall carbon nanotubes (MWNT), single wall carbon nanotubes (SWNT), and inorganic fullerene-like (IF) supramolecules of metal dichalcogenide.

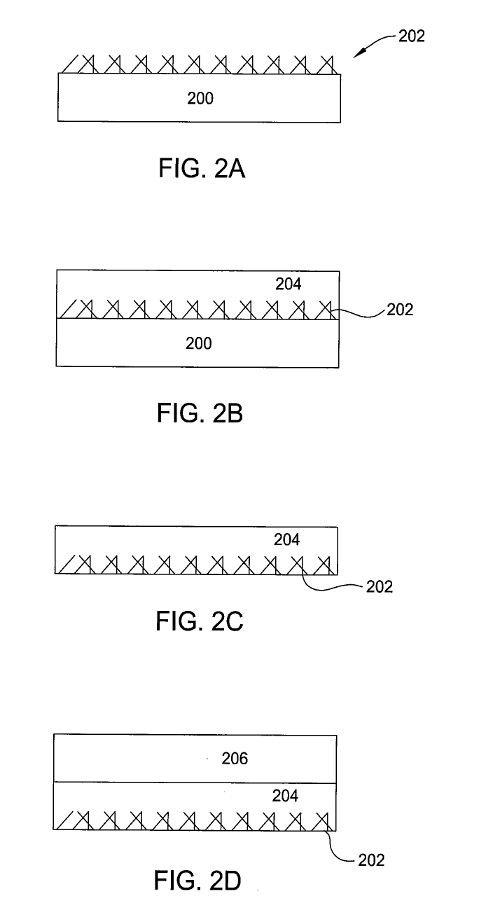

FIGS. 2A-2D show a polishing pad at various stages of a manufacturing process. In FIG. 2A, a plurality of carbon nanotubes 202 are deposited onto a substrate 200 surface using a deposition process, such as chemical vapor deposition (CVD), plasma enhanced chemical vapor deposition (PECVD), physical vapor deposition (PVD), atomic layer deposition (ALD), laser ablation, or other suitable deposition process. In one embodiment, the carbon nanotubes may be formed by controlling deposition parameters to be substantially perpendicular to the substrate 200 surface. By having the carbon nanotubes 202 substantially perpendicular to the substrate 200 surface, the material removal rate, when polishing, may be improved. Additionally, scratching of the material to be polished may be reduced.

A polyurethane coating 204 may be applied over the substrate 200 and the carbon nanotubes 202. Thereafter, the substrate 200 may be removed and a substrate pad 206 may be added over the polyurethane coating 204 opposite to the carbon nanotubes 202.

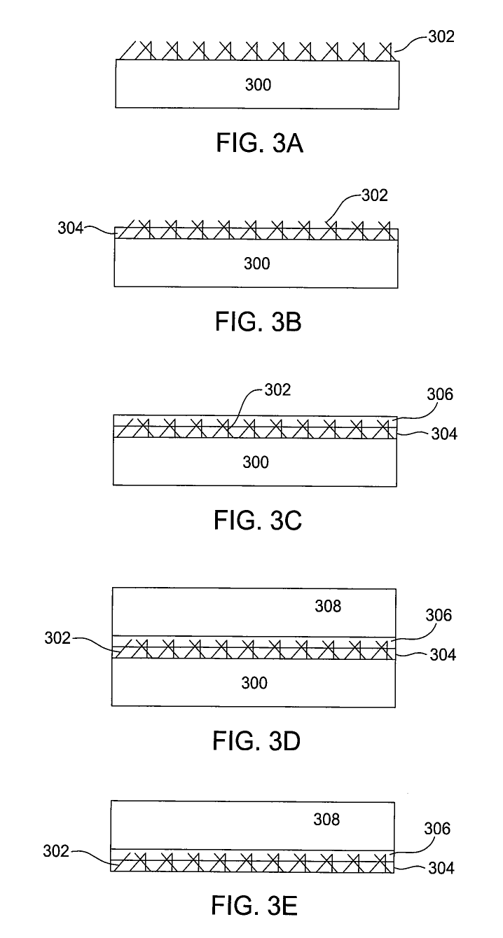

FIGS. 3A-3E show a polishing pad at various stages of a manufacturing process according to another embodiment. In FIG. 3A, a plurality of carbon nanotubes 302 are deposited onto a substrate 300 surface. In one embodiment, the carbon nanotubes may be substantially perpendicular to the substrate 300 surface. By having the carbon nanotubes 302 substantially perpendicular to the substrate 300 surface, the material removal rate, when polishing, may be improved. Additionally, scratching of the material to be polished may be reduced.

A first polyurethane coating 304 may be deposited over the substrate 300 and the nanotubes 302 such that a portion of the carbon nanotubes 302 remain uncovered. Thereafter, a hard line material coating 306 may be deposited over the first polyurethane coating 304 such that the carbon nanotubes 302 are substantially covered. Then, a second polyurethane coating 308 may be deposited over the hard line material coating 306. The substrate 300 may then be removed.

The nanotubes may be treated or left untreated. One example of a surface treatment that may be used is grafting. Another example of a surface treatment is self assembled monolayers of nanotubes.

In one embodiment, the amount of carbon nanotubes that may be used is between about 0.5 phr (part per hundred parts of resin) to about 4 phr. In one embodiment, the amount of carbon nanotubes may be between about 0.5 phr to about 5 phr. In another embodiment, the amount of carbon nanotubes may be between about 2 phr to about 3 phr. The nanoparticles may be randomly arranged or aligned. In one embodiment, fluorescent nano-particles may be used to monitor a polishing pads wearout. The nanoparticles may improve the mechanical properties and the wearout properties of the polishing pad.

While the foregoing is directed to embodiments of the invention, other and further embodiments of the invention may be devised without departing from the basic scope thereof, and the scope thereof is determined by the claims that follow.

What is claimed is:

1. A polishing media, comprising:
a base portion having a chemical characteristic and a first physical characteristic, and
a plurality of discrete particles interspersed in the base portion, each of the plurality of discrete areas having a second physical characteristic that is different than the first physical characteristic, wherein the chemical characteristic of the base portion is maintained.

2. The polishing media of claim 1, wherein the base portion comprises a polyurethane material.

3. The polishing media of claim 1, wherein each of the discrete particles comprise a nano-scale structure.

4. The polishing media of claim 3, wherein the nano-scale structure is selected from the group of organic particles, inorganic particles, compounds or derivatives of organic and inorganic particles, or combinations thereof.

5. The polishing media of claim 3, wherein the nano-scale structure comprises carbon.

6. The polishing media of claim 3, wherein the nano-scale structure is selected from the group of nanotubes, molecular rings, or combinations thereof.

7. The polishing media of claim 3, wherein the nano-scale structure is selected from the group of carbon nanotubes, carbon rings, or combinations thereof.

8. The polishing media of claim 3, wherein the nano-scale structure is selected from the group consisting of inorganic particles, inorganic compounds, derivatives of inorganic compounds, and combinations thereof.

9. The polishing media of claim 8, wherein the nano-scale structure is selected from the group consisting of nanotubes, molecular rings, and combinations thereof.

10. A polishing article, comprising:
a polyurethane base material having a first chemical property and a first physical property; and
a plurality of nano-scale structures having a second physical property that is different than the first physical property, the plurality of nano-scale structures disposed in or on the base material, wherein the first chemical property of the base material is unchanged.

11. The polishing article of claim 10, wherein the nano-scale structure is selected from the group of organic particles, compounds or derivatives of organic particles, or combinations thereof.

12. The polishing article of claim 11, wherein the nano-scale structure comprises carbon.

13. The polishing article of claim 11, wherein the nano-scale structure is selected from the group of nanotubes, molecular rings, or combinations thereof.

14. The polishing article of claim 11, wherein the nano-scale structure is selected from the group of carbon nanotubes, carbon rings, or combinations thereof.

15. The polishing article of claim 11, wherein the nano-scale structure is selected from the group consisting of inorganic particles, inorganic compounds, derivatives of inorganic particles, and combinations thereof.

16. The polishing article of claim 15, wherein the nano-scale structure is selected from the group consisting of nanotubes, molecular rings, and combinations thereof.

17. A method for forming a polishing media for use as a polishing article, comprising:
providing a polymer matrix having a first chemical property and a first physical property;
adding a concentration of nano-scale structures having a second physical property that is different than the first physical property to the polymer matrix in a manner that substantially maintains the first chemical property of the polymer matrix;
curing the polymer matrix; and
skiving the cured polymer matrix into sheets or blocks.

18. The method of claim 17, wherein the concentration is about 1% of the final weight of the cured polymer matrix.

19. The method of claim 17, wherein the adding includes mixing the nano-scale structures with the polymer matrix.

20. The method of claim 17, wherein the adding includes growing the nano-scale structures in the polymer matrix.

21. The method of claim 17, wherein the nano-scale structure is selected from the group of organic particles, compounds or derivatives of organic particles, or combinations thereof.

22. The method of claim 21, wherein the nano-scale structure comprises carbon.

23. The method of claim 21, wherein the nano-scale structure is selected from the group of carbon nanotubes, carbon rings, or combinations thereof.

24. The method of claim 17, wherein the nano-scale structure is selected from the group consisting of inorganic particles, inorganic compounds, derivatives of inorganic particles, and combinations thereof.

25. The method of claim 24, wherein the nano-scale structure is selected from the group of nanotubes, molecular rings, or combinations thereof.
